(19) United States
(12) Patent Application Publication
(10) Pub. No.: US 2026/0023214 A1
(43) Pub. Date: Jan. 22, 2026

(54) OPTICAL WAVEGUIDE AND METHOD FOR MANUFACTURING THE SAME, AND AUGMENTED REALITY DISPLAY APPARATUS

(71) Applicant: Beijing Zitiao Network Technology Co., Ltd., Beijing (CN)

(72) Inventors: Wei TAN, Beijing (CN); Hao TANG, Beijing (CN); Xiaokai LI, Beijing (CN)

(21) Appl. No.: 19/112,117

(22) PCT Filed: Apr. 22, 2024
(86) PCT No.: PCT/CN2024/089114

§ 371 Date: Mar. 14, 2025

(30) Foreign Application Priority Data
Apr. 23, 2023 (CN) 202310442683.5

(51) Int. Cl. G02B 6/12; G02B 6/132; G02B 27/01

(52) U.S. Cl. CPC G02B 6/12004; G02B 6/132; G02B 27/0101; G02B 2006/12038; G02B 2006/12107

(57) ABSTRACT

An optical waveguide, a method for manufacturing the same, and an augmented reality display device. The optical waveguide includes: a substrate; a grating being arranged on a surface of the substrate and being located in a first region; a support layer being arranged on the surface of the substrate and being located in at least portion of a second region, and the surface of the support layer away from the substrate not being lower than the surface of the grating away from the substrate; an adhesive layer being located in a third region; and a protective layer being connected to the substrate through the adhesive layer, the grating, the support layer and the bonding layer are all located between the substrate and the protective layer.

The present application claims priority to Chinese Patent Application No. 202310442683.5 filed on Apr. 23, 2023, the disclosure of which is incorporated herein by reference in its entirety as part of the present application.

### TECHNICAL FIELD

The present disclosure relates to an optical waveguide and a method for manufacturing the same, and an augmented reality display apparatus.

### BACKGROUND

In recent years, as a next-generation computing platform, an augmented reality display apparatus has attracted wide attention. At present, optical display technologies mainly include an array reporting scheme, a volume holographic scheme, a birdbath scheme, a free-form surface scheme, and the like. A diffraction optical waveguide scheme based on surface relief is regarded as one of mainstream optical display schemes for an augmented reality display apparatus product due to its small size, light weight, high transmittance, easy implementation in the form of glasses, and good wearing experience. Diffraction optical waveguide technologies are mainly divided into a one-dimensional architecture and a two-dimensional architecture. The one-dimensional scheme includes a coupling-in grating, a turning grating, and a coupling-out grating, and the two-dimensional scheme only includes the coupling-in grating and the coupling-out grating. The basic principle thereof is that the coupling-in grating couples light from an optical machine into the waveguide and propagates forward in the waveguide through full emission, and the light is coupled out through the turning grating or the coupling-out grating after pupil expansion, so that ambient light is fused with virtual information and finally reaches human eyes to achieve an augmented reality effect. In the current waveguide manufacturing process, a glass cover plate is usually laminated on a surface of the grating of the waveguide to protect the grating. However, due to the continuous thinning of the glass cover plate and the optical waveguide itself, the rigidity thereof gradually decreases, so that when the optical waveguide is subjected to an external force, the glass cover plate contacts with the surface of the grating of the waveguide, and the grating structure partially or completely collapses, resulting in a sharp decline in the performance of the optical waveguide. Therefore, the present disclosure aims to provide an optical waveguide to solve the above problems.

### SUMMARY

The present disclosure aims to solve at least one of the technical problems in the related art to some extent.

In an aspect of the present disclosure, an optical waveguide is provided, including: a substrate; a grating, the grating being disposed on a surface of the substrate and located in a first region; a support layer, the support layer being disposed on the surface of the substrate and located in at least a portion of a second region, a surface of the support layer away from the substrate being not lower than a surface of the grating away from the substrate; an adhesive layer, the adhesive layer being disposed on the surface of the substrate and located in a third region; and a protective layer, the protective layer being directly opposite to the substrate, the protective layer being connected to the substrate through the adhesive layer, and the grating, the support layer, and the adhesive layer being all located between the substrate and the protective layer, where the second region is disposed at a periphery of the first region, and the third region is disposed at a periphery of the second region.

In the optical waveguide according to the present disclosure, the support layer is disposed between the substrate and the protective layer, and a thickness of the support layer is not lower than a thickness of the grating, so that a supporting force for the protective layer is improved. When the optical waveguide is subjected to an external force, the external force first acts on the support layer, so that the grating structure is prevented from collapsing due to the pressing of the grating by the protective layer, and the service life of the optical waveguide is extended to some extent.

According to some embodiments of the present disclosure, the thickness of the support layer is less than or equal to a thickness of the adhesive layer.

According to some embodiments of the present disclosure, the thickness of the grating is the same as the thickness of the adhesive layer, and two ends of the support layer in an extending direction are respectively connected to the grating and the adhesive layer, the extending direction intersecting with a thickness direction of the support layer.

According to some embodiments of the present disclosure, the adhesive layer is continuous without interruption in the third region.

According to some embodiments of the present disclosure, a transmittance of the support layer to visible light is not less than 80%.

According to some embodiments of the present disclosure, a material for forming the support layer is an inorganic material, and the inorganic material includes at least one of the group consisting of SiNx, ITO, and SiO₂.

According to some embodiments of the present disclosure, the thickness of the support layer is in a range from 1 to 500 μm.

In another aspect of the present disclosure, a method for manufacturing the aforementioned optical waveguide is provided, including: providing a substrate; forming a grating in a first region of a surface of the substrate; providing a protective layer, and forming a support layer in a second region of a surface of the protective layer, a thickness of the support layer being not less than a thickness of the grating; and bonding the substrate and the protective layer together by an adhesive layer using a bonding process, the grating and the support layer being both located between the substrate and the protective layer, and the first region and the second region having no overlapping portion. Therefore, the method is simple in process, and the optical waveguide manufactured by the method has all the features and advantages of the aforementioned optical waveguide, which will not be repeated here. In general, at least the advantages of higher supporting force of the protective layer and longer service life of the optical waveguide are provided.

According to some embodiments of the present disclosure, a method for forming the support layer includes: forming a thin-film material on the surface of the protective layer, the thin-film material completely covering the substrate; and patterning the thin-film material to form the support layer.

According to some embodiments of the present disclosure, a method for forming the grating includes: forming an imprinting adhesive material on the surface of the substrate; and performing imprinting treatment on the imprinting adhesive material to form the grating.

According to some embodiments of the present disclosure, the adhesive layer is formed in a third region, the second region is disposed at a periphery of the first region, and the third region is disposed at a periphery of the second region.

In yet another aspect of the present disclosure, an augmented reality display apparatus is provided, including the aforementioned optical waveguide. Therefore, the augmented reality display apparatus has all the features and advantages of the aforementioned optical waveguide, which will not be repeated here. In general, at least the advantages of long service life and high reliability are provided.

### BRIEF DESCRIPTION OF DRAWINGS

The above and/or additional aspects and advantages of the present disclosure will become apparent and easily understood from the description of the embodiments in conjunction with the following drawings, in which:

FIG. 1 shows a schematic structural diagram of an optical waveguide in a related art;

FIG. 2 shows a schematic structural diagram of an optical waveguide in a related art when the optical waveguide is subjected to an external force;

FIG. 3 shows a schematic structural diagram of an optical waveguide according to an embodiment of the present disclosure;

FIG. 4 shows a schematic structural diagram of an optical waveguide according to another embodiment of the present disclosure;

FIG. 5 shows a schematic structural diagram of an optical waveguide according to another embodiment of the present disclosure;

FIG. 6 shows a schematic structural diagram of an optical waveguide according to another embodiment of the present disclosure;

FIG. 7 shows a schematic structural diagram of an optical waveguide according to another embodiment of the present disclosure;

FIG. 8 shows a schematic structural diagram of an optical waveguide according to another embodiment of the present disclosure;

FIG. 9 shows a schematic structural diagram of an optical waveguide according to another embodiment of the present disclosure;

FIG. 10 shows a schematic flowchart of manufacturing an optical waveguide according to an embodiment of the present disclosure;

FIG. 11 shows a schematic flowchart of manufacturing a grating according to an embodiment of the present disclosure;

FIG. 12 shows a schematic flowchart of manufacturing a waveguide sheet according to another embodiment of the present disclosure;

FIG. 13 shows a schematic diagram of cutting a shape of a waveguide sheet according to an embodiment of the present disclosure;

FIG. 14 shows a schematic flowchart of manufacturing a support layer according to an embodiment of the present disclosure;

FIG. 15 shows a schematic diagram of cutting a shape of a protective layer according to an embodiment of the present disclosure;

FIG. 16 shows a schematic structural diagram of an adhesive layer according to an embodiment of the present disclosure; and

FIG. 17 shows a schematic structural diagram of an adhesive layer in a related art.

### REFERENCE NUMERALS

1: optical waveguide; 11: substrate; 111: first region; 112: second region; 113: third region; 12: protective layer; 13: grating; 130: imprinting adhesive material; 131: imprinting sub-plate; 14: adhesive layer; 15: support layer; 150: thin-film material; 151: support unit; 16: optical functional layer.

### DETAILED DESCRIPTION

Embodiments of the present disclosure are described in detail below. The embodiments described below are exemplary, and are only used to explain the present disclosure, but not to limit the present disclosure. Where specific techniques or conditions are not indicated in the embodiments, the techniques or conditions described in the literature in the field or the product specification shall be referred to. Reagents or instruments used without indicating the manufacturer are conventional products that can be obtained commercially.

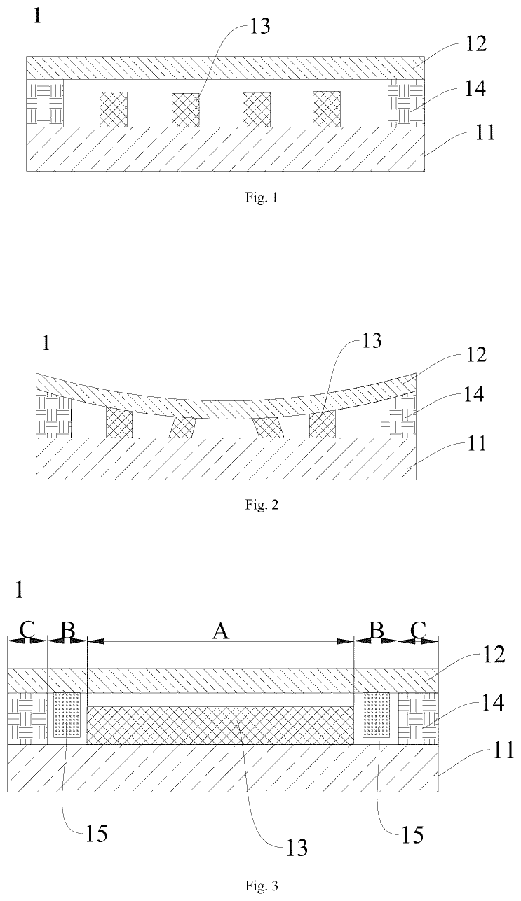

As mentioned above, when an optical waveguide 1 in the related art is subjected to an external force, a cover plate (a protective layer 12) contacts with a grating 13 of the optical waveguide 1, causing the partial or completely collapse of the grating 13 (referring to FIG. 1 and FIG. 2), which affects the performance of the optical waveguide 1.

In an aspect of the present disclosure, an optical waveguide 1 is provided, which, referring to FIG. 3 to FIG. 8, includes: a substrate 11, a protective layer 12, a grating 13, an adhesive layer 14, and a support layer 15. The grating 13 is disposed on a surface of the substrate 11 and located in a first region A, the support layer 15 is disposed on the surface of the substrate 11 and located in at least a portion of a second region B, a surface of the support layer 15 away from the substrate 11 is not lower than a surface of the grating 13 away from the substrate 11, the adhesive layer 14 is disposed on the surface of the substrate 11 and located in a third region C, the protective layer 12 is directly opposite to the substrate 11, the protective layer 12 is connected to the substrate 11 through the adhesive layer 14, and the grating 13, the support layer 15, and the adhesive layer 14 are all located between the substrate 11 and the protective layer 12, where the second region B is disposed at a periphery of the first region A, and the third region C is disposed at a periphery of the second region B. Specifically, a region between the substrate 11, the protective layer 12, the grating 13, and the adhesive layer 14 is the second region B, the support layer 15 is disposed in at least a portion of the second region B, and a thickness of the support layer 15 is not lower than a thickness of the grating 13. For example, the support layer 15 may be connected to the grating 13 or arranged at an interval from the grating 13. It should be noted that, in the present disclosure, “arranged to face” means that the substrate 11 and the protective layer 12 have the same size, and an orthographic projection of the protective layer 12 on the substrate 11 coincides with the substrate 11.

In the optical waveguide 1 according to the present disclosure, the support layer 15 is disposed between the substrate and the protective layer 12, and the thickness of the support layer 15 is not lower than the thickness of the grating 13, so that a supporting force for the protective layer 12 is improved. When the optical waveguide 1 is subjected to an external force, the external force first acts on the support layer 15, so that the grating structure is prevented from collapsing due to the pressing of the grating 13 by the protective layer 12, and the service life of the optical waveguide 1 is extended to some extent.

According to some embodiments of the present disclosure, shapes of the first region A, the second region B, and the third region C are not particularly limited. For example, the first region A may have a same shape as an optical path region of the optical waveguide 1, the second region B surrounds the first region A, and the third region C surrounds the second region B in a ring shape.

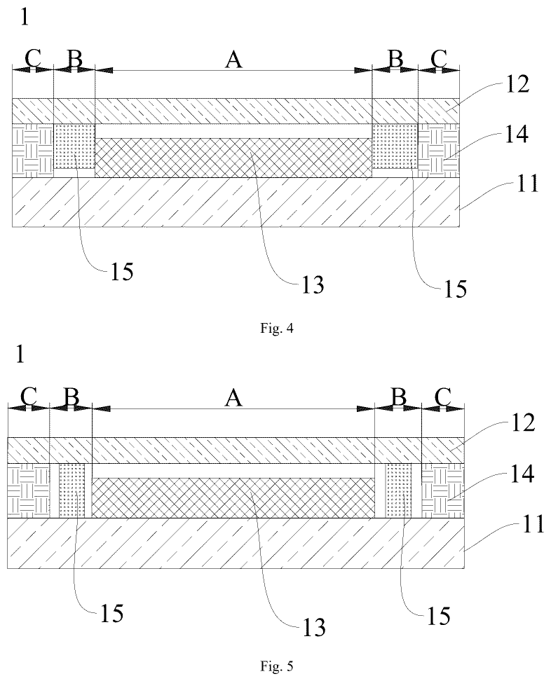

According to some embodiments of the present disclosure, referring to FIG. 3 to FIG. 8. the thickness of the support layer 15 is less than or equal to a thickness of the adhesive layer 14. For example, when the thickness of the support layer 15 is less than the thickness of the adhesive layer 14, referring to FIG. 3, the support layer 14 may be disposed between the adhesive layer 14 and the grating 13 (that is, two ends of the support layer 15 are both not connected to the adhesive layer 14 and the grating 13), or one end of the support layer 14 is connected to the adhesive layer 14 and another end is not connected to the grating 13 (not shown), or one end of the support layer 14 is connected to the grating 13 and another end is not connected to the adhesive layer 14 (not shown), or two ends of the support layer 15 are respectively connected to the adhesive layer 14 and the grating 13 (referring to FIG. 4); similarly, when the thickness of the support layer 15 is the same as the thickness of the adhesive layer 14. the arrangement of the support layer 15 may also refer to the above situations, which will not be repeated here.

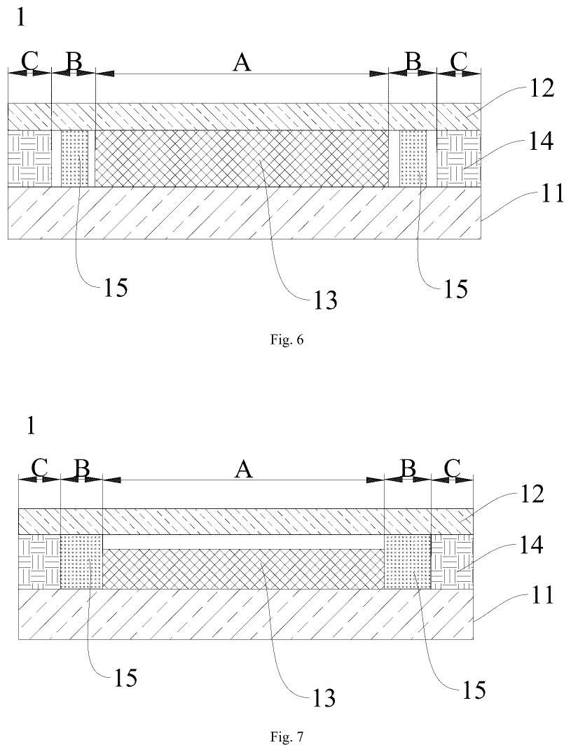

According to some embodiments of the present disclosure, the thickness of the grating 13 is not particularly limited. For example, the thickness of the grating 13 may be lower than the thickness of the adhesive layer 14 (referring to FIG. 3 to FIG. 5), or the thickness of the grating 13 may be the same as the thickness of the adhesive layer 14 (referring to FIG. 6).

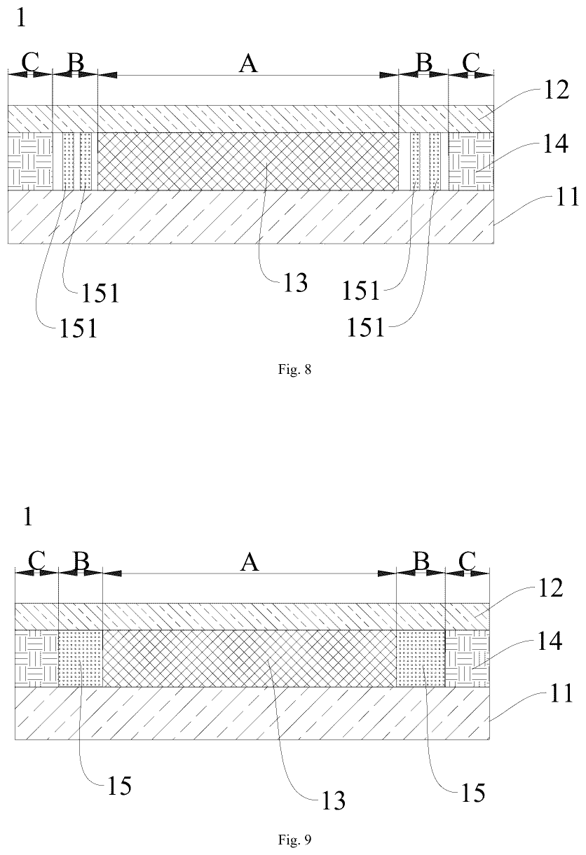

It should be noted that, the support layer 15 may be continuous, or the support layer 15 may be formed by a plurality of support units 151 arranged at an interval (referring to FIG. 8).

According to some embodiments of the present disclosure, referring to FIG. 9, the thickness of the grating 13 is the same as the thickness of the adhesive layer 14, and two ends of the support layer 15 in an extending direction are respectively connected to the grating 13 and the adhesive layer 14, the extending direction intersecting with a thickness direction of the support layer 15. For example,. the extending direction of the support layer 15 is perpendicular to the thickness direction of the support layer 15. That is, the support layer 15 is disposed in the entire second region B, and a surface of the support layer 15 away from the substrate 11 is flush with a surface of the grating 13 away from the substrate 11 and a surface of the adhesive layer 14 away from the substrate 11. Therefore, the support layer 15 is connected to the adhesive layer 14, and the support layer 15 can be used as a barrier layer to prevent the adhesive layer 14 from being deformed before curing, prevent bubbles from being generated in the adhesive layer 14, improve the flatness of the surface of the adhesive layer 14, improve the parallelism of the bonding of the substrate 11 and the protective layer 12, and prevent the bonding edges from being irregular.

According to some embodiments of the present disclosure, the support layer 15 is disposed in the entire second region B, and the thickness of the support layer 15 is the same as the thickness of the grating 13 and the thickness of the adhesive layer 14. The adhesive layer 14 is continuous without interruption in the third region C, that is, the adhesive layer 14 is disposed in the entire third region C without any openings. Therefore, it can prevent water vapor from entering the optical waveguide 1 when the optical waveguide 1 is in a high-temperature and high-humidity environment, thereby improving the reliability of the optical waveguide 1 in the high-temperature and high-humidity environment.

According to some embodiments of the present disclosure, a transmittance of the support layer 15 to visible light is not less than 80%. Therefore, when the protective layer 12 is a glass cover plate, the appearance of the optical waveguide 1 can be further improved.

According to some embodiments of the present disclosure, a material for forming the support layer 15 is not particularly limited, and those skilled in the art can select it according to actual needs. Specifically, in the present disclosure, the material for forming the support layer 15 may be an inorganic material, specifically, the inorganic material may include at least one of the group consisting of SiNx, ITO, and SiO₂.

According to some embodiments of the present disclosure, the thickness of the support layer 15 may be in a range from 1 to 500 μm. Specifically, the thickness of the support layer 15 may be 30 μm, 50 μm, 70 μm, 90 μm, 110 μm,130 μm, 150 μm, 170 μm, 190 μm, 210 μm, 230 μm, 250 μm, 270 μm, 290 μm, 310 μm, 330 μm, 350 μm, 370 μm, 390 μm, 410 μm, 430 μm, 450 μm, 470 μm, or 490 μm, etc.

In another aspect of the present disclosure, a method for manufacturing the aforementioned optical waveguide 1 is provided, including: providing the substrate 11; forming the grating 13 in the first region A of the surface of the substrate 11; providing the protective layer 12, and forming the support layer 15 in the second region B of a surface of the protective layer 12, the thickness of the support layer 15 being not less than the thickness of the grating 13; and bonding the substrate 11 and the protective layer 12 together by the adhesive layer 14 using a bonding process, the grating 13 and the support layer 15 being both located between the substrate 11 and the protective layer 12, and the first region A and the second region B having no overlapping portion. Therefore, the method is simple in process, and the optical waveguide 1 manufactured by the method has all the features and advantages of the aforementioned optical waveguide 1, which will not be repeated here. In general, at least the advantages of relatively high supporting force of the protective layer 12 and relatively long service life of the optical waveguide 1 are provided.

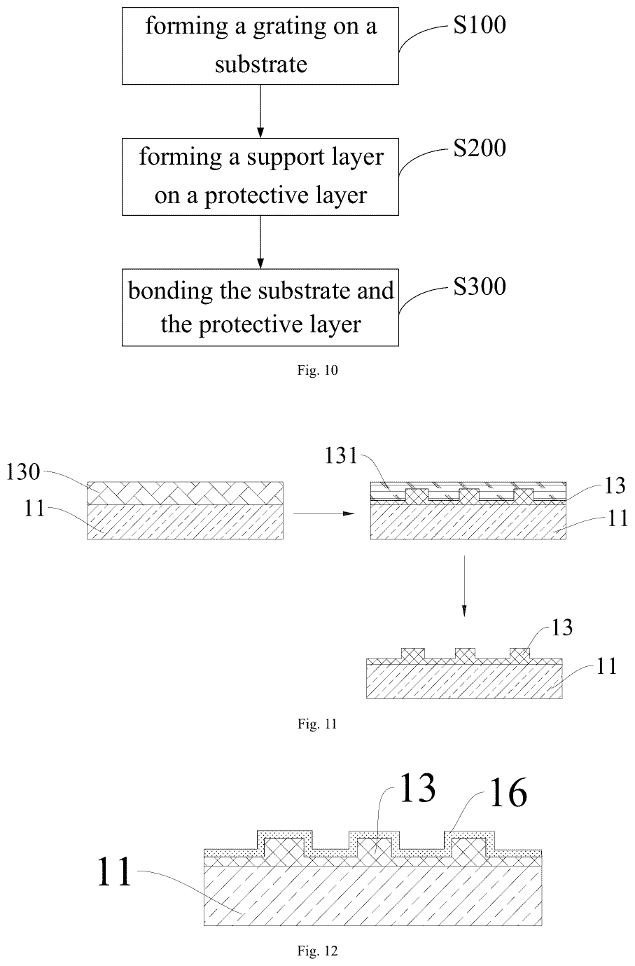

Each step of the method is described in detail below. Referring to FIG. 10, the method includes:
S100: forming a grating on a substrate.

In this step, the grating 13 is formed in the first region A of the surface of the substrate 11.

According to some embodiments of the present disclosure, a method for forming the grating 13 includes:
S110: forming an imprinting adhesive material on the surface of the substrate.

Specifically, referring to FIG. 11, the imprinting adhesive material 130 may be coated on the substrate 11 by a coating process, and a thickness of the imprinting adhesive material 130 may be in a range from 50 to 5000 nm, for example, 100 nm, 500 nm, 1000 nm, 1500 nm, 2000 nm, 2500 nm, 3000 nm, 3500 nm, 4000 nm, or 4500 nm, etc. According to some embodiments of the present disclosure, the coating process may include at least one of the group consisting of spin coating, inkjet printing (IJP), and electroplating (Split) to form the imprinting adhesive material 130 on one side of the substrate 11.

According to some embodiments of the present disclosure, an adhesion promoting layer (not shown) may also be disposed between the imprinting adhesive material 130 and the substrate 11 to prevent the imprinting adhesive material 130 from falling off.

According to some embodiments of the present disclosure, the material type for forming the grating 13 is not particularly limited, and may be an organic material or an inorganic material.

According to some embodiments of the present disclosure, the substrate 11 may be a high refractive substrate 11.
S120: performing imprinting treatment on the imprinting adhesive material to form the grating.

Specifically, referring to FIG. 11, a grating 13 master plate is manufactured, a surface of the grating 13 master plate is cleaned and subjected to anti-sticking treatment, and soft film imprinting, ultraviolet curing, and demoulding are performed using a flexible substrate, so that a plurality of imprinting sub-plates 131 can be replicated. An imprinting device is used to fix the imprinting sub-plate 131, and the imprinting adhesive material 130 by coating is imprinted, exposed, and demoulded to obtain a waveguide sheet containing the grating 13. According to some embodiments of the present disclosure, the imprinting method may be Roll to Plate or Plate to Plate, and a wavelength in the ultraviolet curing process may be 365 nm.

According to some embodiments of the present disclosure, referring to FIG. 12, an optical functional layer 16 may also be formed on a surface of the grating 13 away from the substrate 11. Specifically, the method for forming the optical functional layer may be at least one of the group consisting of evaporation, atomic layer deposition, and physical vapor deposition. According to some specific embodiments of the present disclosure, a material for forming the optical functional layer may be at least one of the group consisting of TiO₂, Si₃N₄, and HfO₂. A thickness of the optical functional layer may be in a range from 20 to 500 nm, for example, 50 nm, 100 nm, 150 nm, 200 nm, 250 nm, 300 nm, 350 nm, 400 nm, or 450 nm, etc.

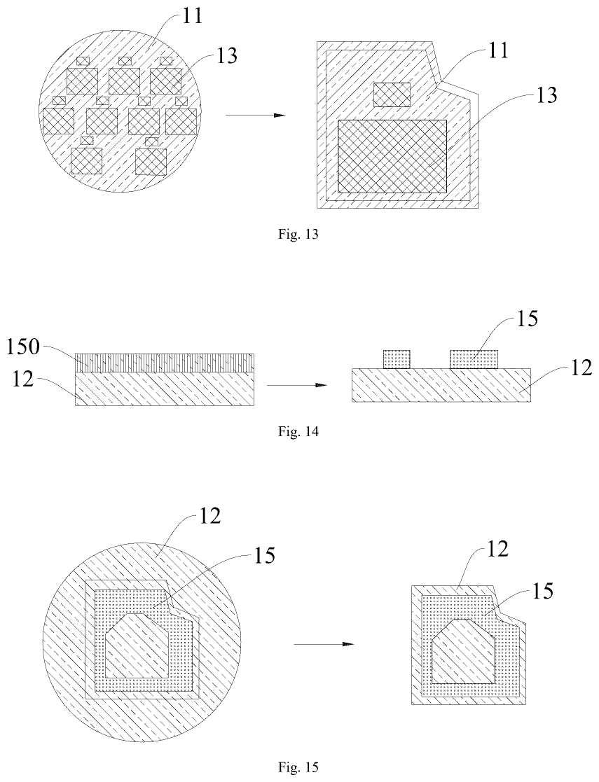

According to some embodiments of the present disclosure, referring to FIG. 13, a shape of the waveguide sheet may also be cut according to product requirements. Specifically, at least one of the group consisting of picosecond laser cutting, carbon dioxide laser dicing, or numerical control cutting may be used for cutting.
S200: forming a support layer on a protective layer.

Specifically, the support layer 15 is formed in the second region B of a surface of at least a portion of the protective layer 12, and the thickness of the support layer 15 is not less than the thickness of the grating 13.

According to some embodiments of the present disclosure, the protective layer 12 may be a glass cover plate or a resin.

According to some embodiments of the present disclosure, referring to FIG. 14, a method for forming the support layer 15 includes:
S210: forming a thin-film material on the protective layer.

Specifically, the thin-film material 150 is formed on the surface of the protective layer 12, and the thin-film material 150 completely covers the substrate 11. According to some embodiments of the present disclosure, the thin-film material 150 may be formed on the substrate 11 by plasma enhanced vapor chemical deposition (PECVD) or physical vapor deposition (PVD). According to some specific embodiments of the present disclosure, a raw material for forming the thin-film material 150 may be an inorganic material, and the inorganic material may include at least one of the group consisting of SiNx, ITO, and SiO₂.

According to some embodiments of the present disclosure, the protective layer 12 may be high-transmittance glass, tempered glass, or sapphire. The thickness of the protective layer 12 may be in a range from 0.001 to 1 mm.
S220: patterning the thin-film material to form the support layer.

Specifically, referring to FIG. 14, the thin-film material 150 on the protective layer 12 corresponding to the first region A and the third region C may be completely etched away by exposure, development, etching, glue removal, and cleaning processes. It should be noted that the relevant parameters in the exposure, development, etching, glue removal, and cleaning processes may be designed with reference to the parameters in the related art.

According to some embodiments of the present disclosure, the thickness of the formed support layer 15 is less than or equal to the thickness of the adhesive layer 14.

According to some embodiments of the present disclosure, the support layer 15 is formed in the entire second region B, that is, the opposite ends of the support layer 15 are respectively connected to the grating 13 and the adhesive layer 14. Therefore, the support layer 15 is connected to the adhesive layer 14, and the support layer 15 can be used as a barrier layer to prevent the adhesive layer 14 from being deformed before curing, thereby improving the flatness of the surface of the adhesive layer 14 and the parallelism of the bonding of the substrate 11 and the protective layer 12.

According to some embodiments of the present disclosure, referring to FIG. 15, the shape of the protective layer 12 may also be cut according to the shape of the waveguide sheet.
S300: bonding the substrate and the protective layer.

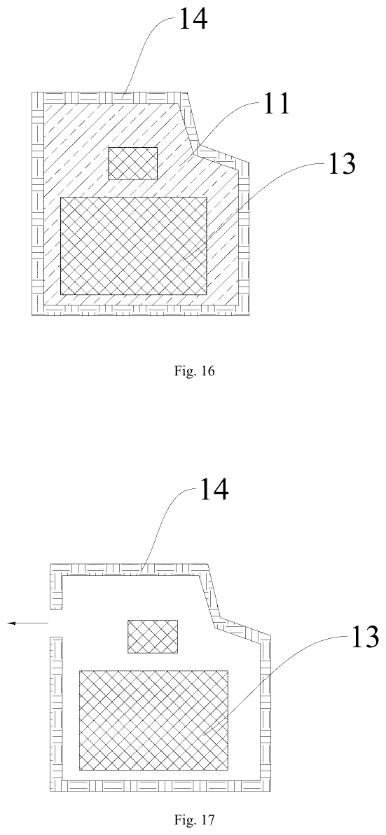

In this step, referring to FIG. 16, the substrate 11 and the protective layer 12 are bonded together by the adhesive layer 14 using a bonding process, and the first region A of the surface of the substrate 11 and the second region B of the surface of the protective layer 12 have no overlapping portion.

Specifically, a side of the substrate 11 provided with the grating 13 and a side of the protective layer 12 provided with the support layer 15 are bonded. Specifically, an optical adhesive (OCA) or a liquid optical adhesive (OCR) may be used for bonding.

According to some embodiments of the present disclosure, the thickness of the adhesive layer 14 is greater than or equal to the thickness of the support layer 15.

For example, when there is air between the grating 13 and the adhesive layer 14, openings need to be reserved in the adhesive layer 14 to exhaust air pressure during bonding process between the substrate 11 and the protective layer 12. In the present disclosure, the support layer 15 is disposed between the grating 13 and the adhesive layer 14, so that there is no need to reserve openings in the adhesive layer 14. According to some embodiments of the present disclosure, referring to FIG. 16, the adhesive layer 14 is formed in the entire third region C. Specifically, the second region B is disposed at the periphery of the first region A, and the third region C is disposed at the periphery of the second region B, that is, the adhesive layer 14 is continuous without interruption in the third region C. Therefore, it can prevent bubbles from being generated at bonding edges, thereby improving the appearance of the optical waveguide 1. Moreover, it can prevent water vapor from entering the optical waveguide 1, thereby improving the reliability of the optical waveguide 1 in a high-temperature and high-humidity environment.

In yet another aspect of the present disclosure, an augmented reality display apparatus is provided, including the aforementioned optical waveguide 1. Therefore, the augmented reality display apparatus has all the features and advantages of the aforementioned optical waveguide 1, which will not be repeated here. In general, at least the advantages of long service life and high reliability are provided.

In the description of the present disclosure, it should be understood that. the terms “center”. “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate the orientation or position relationship based on the orientation or position relationship shown in the drawings, which are only used to facilitate the description of the present disclosure and simplify the description, but not to indicate or imply that the device or clement referred to must have a specific orientation and be constructed and operated in a specific orientation, and thus cannot be construed as a limitation of the present disclosure.

In addition, the terms “first” and “second” are only used for descriptive purposes. and cannot be construed as indicating or implying relative importance or implicitly indicating the number of indicated technical features. Thus, the features defined as “first” and “second” may explicitly or implicitly include one or more of these features. In the description of the present disclosure, the meaning of “a plurality of” is two or more, unless otherwise specifically defined.

In the present disclosure, unless otherwise expressly specified and limited, the terms “mounted”, “connected”, “connected to”, “fixed”, and the like should be construed broadly, for example, it may be a fixed connection, a detachable connection, or an integral connection; it may be a mechanical connection or an electrical connection; it may be a direct connection or an indirect connection through an intermediate medium, or it may be an internal communication between two elements or an interaction relationship between two elements. For those of ordinary skill in the art, the specific meanings of the above terms in the present disclosure can be understood according to specific situations.

In the present disclosure, unless otherwise expressly specified and limited, the first feature being “on” or “under” the second feature may be that the first feature is in direct contact with the second feature. or the first feature is in indirect contact with the second feature through an intermediate medium. Moreover, the first feature being “above”, “over”, or “on top of” the second feature may be that the first feature is directly above or obliquely above the second feature, or merely indicates that the first feature is at a higher horizontal level than the second feature. The first feature being “below”, “under”, or “beneath” the second feature may be that the first feature is directly below or obliquely below the second feature, or merely indicates that the first feature is at a lower horizontal level than the second feature.

In the description of the present disclosure, the description referring to the terms “one embodiment”, “some embodiments”, “example”, “specific example”, or “some examples”, etc. means that the specific features, structures, materials, or characteristics described in conjunction with the embodiments or examples are included in at least one embodiment or example of the present disclosure. In the present disclosure, the schematic expressions of the above terms are not necessarily directed to the same embodiments or examples. Moreover, the specific features, structures, materials, or characteristics described may be combined in any one or more embodiments or examples in a suitable manner. In addition, without contradiction, those skilled in the art may combine and combine different embodiments or examples and features of different embodiments or examples described in the present disclosure.

Although the embodiments of the present disclosure have been shown and described above, it should be understood that the above embodiments are exemplary and should not be construed as a limitation of the present disclosure, and those of ordinary skill in the art may make changes, modifications, substitutions, and variations to the above embodiments within the scope of the present disclosure.

1. An optical waveguide, comprising:
a substrate;
a grating, wherein the grating is disposed on a surface of the substrate and located in a first region;
a support layer, wherein the support layer is disposed on the surface of the substrate and located in at least a portion of a second region, and a surface of the support layer away from the substrate is not lower than a surface of the grating away from the substrate;
an adhesive layer, wherein the adhesive layer is disposed on the surface of the substrate and located in a third region; and
a protective layer, wherein the protective layer is directly opposite to the substrate, the protective layer is connected to the substrate through the adhesive layer, and the grating, the support layer, and the adhesive layer are all located between the substrate and the protective layer, the second region is disposed at a periphery of the first region, and the third region is disposed at a periphery of the second region.

2. The optical waveguide according to claim 1, wherein a thickness of the support layer is less than or equal to a thickness of the adhesive layer.

3. The optical waveguide according to claim 2, wherein a thickness of the grating is the same as the thickness of the adhesive layer, and two ends of the support layer in an extending direction are respectively connected to the grating and the adhesive layer, the extending direction intersects with a thickness direction of the support layer.

4. The optical waveguide according to claim 3, wherein the adhesive layer is continuous without interruption in the third region.

5. The optical waveguide according to claim 1, wherein a transmittance of the support layer to visible light is not less than 80%; and
a material for forming the support layer is an inorganic material, the inorganic material comprises at least one of the group consisting of SiNx, ITO, and SiO₂.

6. The optical waveguide according to claim 5, wherein a thickness of the support layer is in a range from 1 to 500 μm.

7. A method for manufacturing an optical waveguide, wherein the optical waveguide comprises:
a substrate;
a grating, wherein the grating is disposed on a surface of the substrate and located in a first region;
a support layer, wherein the support layer is disposed on the surface of the substrate and located in at least a portion of a second region, and a surface of the support layer away from the substrate is not lower than a surface of the grating away from the substrate;
an adhesive layer, wherein the adhesive layer is disposed on the surface of the substrate and located in a third region; and
a protective layer, wherein the protective layer is directly opposite to the substrate, the protective layer is connected to the substrate through the adhesive layer, and the grating, the support layer, and the adhesive layer are all located between the substrate and the protective layer, the second region is disposed at a periphery of the first region, and the third region is disposed at a periphery of the second region,
wherein the method for manufacturing the optical waveguide comprises:
providing the substrate;
forming the grating in the first region of the surface of the substrate;
providing the protective layer, and forming the support layer in the second region of the surface of the protective layer, a thickness of the support layer being not less than a thickness of the grating; and
bonding the substrate and the protective layer together by the adhesive layer using a bonding process, the grating and the support layer being both located between the substrate and the protective layer, and the first region and the second region having no overlapping portion.

8. The method according to claim 7, wherein forming the support layer comprises:
forming a thin-film material on the surface of the protective layer, the thin-film material completely covering the substrate; and
patterning the thin-film material to form the support layer.

9. The method according to claim 7, wherein forming the grating comprises:
forming an imprinting adhesive material on the surface of the substrate; and
performing imprinting treatment on the imprinting adhesive material to form the grating.

10. The method according to claim 7, wherein the adhesive layer is formed in the third region, the second region is disposed at the periphery of the first region, and the third region is disposed at the periphery of the second region.

11. An augmented reality display apparatus, comprising an optical waveguide,
wherein the optical waveguide comprises:
a substrate;
a grating, wherein the grating is disposed on a surface of the substrate and located in a first region;
a support layer, wherein the support layer is disposed on the surface of the substrate and located in at least a portion of a second region, and a surface of the support layer away from the substrate is not lower than a surface of the grating away from the substrate;
an adhesive layer, wherein the adhesive layer is disposed on the surface of the substrate and located in a third region; and
a protective layer, wherein the protective layer is directly opposite to the substrate, the protective layer is connected to the substrate through the adhesive layer, and the grating, the support layer, and the adhesive layer are all located between the substrate and the protective layer, the second region is disposed at a periphery of the first region, and the third region is disposed at a periphery of the second region.

12. The method according to claim 7, wherein the thickness of the support layer is less than or equal to a thickness of the adhesive layer.

13. The method according to claim 7, wherein the thickness of the grating is the same as a thickness of the adhesive layer, and two ends of the support layer in an extending direction are respectively connected to the grating and the adhesive layer, the extending direction intersects with a thickness direction of the support layer.

14. The method according to claim 7, wherein the adhesive layer is continuous without interruption in the third region.

15. The method according to claim 7, wherein a transmittance of the support layer to visible light is not less than 80%; and
a material for forming the support layer is an inorganic material, the inorganic material comprises at least one of the group consisting of SiNx, ITO, and SiO₂.

16. The method according to claim 7, wherein the thickness of the support layer is in a range from 1 to 500 μm.

17. The augmented reality display apparatus according to claim 11, wherein a thickness of the support layer is less than or equal to a thickness of the adhesive layer.

18. The augmented reality display apparatus according to claim 11, wherein a thickness of the grating is the same as the thickness of the adhesive layer, and two ends of the support layer in an extending direction are respectively connected to the grating and the adhesive layer, the extending direction intersects with a thickness direction of the support layer.

19. The augmented reality display apparatus according to claim 11, wherein the adhesive layer is continuous without interruption in the third region.

20. The augmented reality display apparatus according to claim 11, wherein a transmittance of the support layer to visible light is not less than 80%; and
a material for forming the support layer is an inorganic material, the inorganic material comprises at least one of the group consisting of SiNx, ITO, and SiO₂.
